(19) United States
(12) Patent Application Publication
(10) Pub. No.: US 2012/0252658 A1
(43) Pub. Date: Oct. 4, 2012

(54) HONEYCOMB STRUCTURE AND METHOD OF MANUFACTURING HONEYCOMB STRUCTURE

(75) Inventors: Masafumi KUNIEDA, Ibi-Gun (JP); Yosuke Matsukawa, Ibi-Gun (JP)

(73) Assignee: IBIDEN CO., LTD., Ogaki-Shi (JP)

(21) Appl. No.: 13/304,310

(22) Filed: Nov. 24, 2011

(30) Foreign Application Priority Data
Mar. 29, 2011 (JP) PCT/JP2011/057857

(51) Int. Cl. B01J 29/04; B01J 29/08; B01J 29/40; B01J 29/18; B01J 37/08; B01J 29/60; B01J 29/85; B01J 29/83; B01J 37/30; B01J 35/04; B01J 29/65

(52) U.S. Cl. 502/68; 502/87; 502/74; 502/64; 502/73; 502/79; 502/77; 502/78

(57) ABSTRACT

A honeycomb structure includes a honeycomb unit containing zeolite and an inorganic binder and having a plurality of cell walls to define a plurality of cells extending from a first end face to a second end face of the honeycomb unit along a longitudinal direction of the honeycomb unit. The honeycomb unit is manufactured by molding and firing raw material paste containing zeolite particles and the inorganic binder. The zeolite particles have a D50 of approximately 3.6 μm or more. An average pore size of the cell walls is more than or equal to approximately 0.10 μm and less than or equal to approximately 0.50 μm. An average particle size of the cell walls is more than or equal to approximately 3.6 μm and less than or equal to approximately 7.0 μm.

### CROSS-REFERENCE TO RELATED APPLICATIONS

The present application claims priority under 35 U.S.C. §119 to International Application No. PCT/JP2011/057857, filed on Mar. 29, 2011, the entire contents of which are incorporated herein by reference.

### BACKGROUND OF THE INVENTION

1. Field of the Invention

The present invention relates to a honeycomb structure and a method of manufacturing the honeycomb structure.

2. Discussion of the Background

A large number of techniques have been developed in relation to conversion of automobile exhaust gas. With an increase in traffic, however, countermeasures taken against exhaust gas have hardly been satisfactory. Not only in Japan but also globally, is automobile emission control going to be further tightened.

In order to meet such control of exhaust gas, catalyst supports capable of treating predetermined toxic components contained in exhaust gas are used in exhaust gas converting systems. Further, a honeycomb structure is known as a member for such catalyst supports.

Common honeycomb structures have a honeycomb unit. This honeycomb unit has, for example, multiple cells (through holes) extending from one end face to another end face of the honeycomb unit along its longitudinal directions, and these cells are separated from each other by cell walls having a catalyst supported on their surfaces or cell walls formed of a catalyst. Accordingly, in the case of causing exhaust gas to flow through a honeycomb structure having such a honeycomb unit, substances contained in the exhaust gas, such as HC, CO, and/or NOx, are converted by the catalyst supported on the cell walls or the catalyst forming the cell walls, so that these toxic components in the exhaust gas may be treated.

In particular, in systems called SCR (Selective Catalytic Reduction) systems, it is possible to decompose NOx in exhaust gas into nitrogen and water using ammonia. For example, WO 09/141,878A1 discloses a honeycomb structure having a honeycomb unit containing zeolite usable in SCR systems.

The entire contents of WO 09/141,878A1 are incorporated herein by reference.

### SUMMARY OF THE INVENTION

According to an aspect of the present invention, a honeycomb structure includes a honeycomb unit containing zeolite and an inorganic binder and having a plurality of cell walls to define a plurality of cells extending from a first end face to a second end face of the honeycomb unit along a longitudinal direction of the honeycomb unit. The honeycomb unit is manufactured by molding and firing raw material paste containing zeolite particles and the inorganic binder. The zeolite particles have a D50 of approximately 3.6 μm or more. An average pore size of the cell walls is more than or equal to approximately 0.10 μm and less than or equal to approximately 0.50 μm. An average particle size of the cell walls is more than or equal to approximately 3.6 μm and less than or equal to approximately 7.0 μm.

According to another aspect of the present invention, a method of manufacturing a honeycomb structure including a honeycomb unit includes preparing raw material paste containing zeolite particles and the inorganic binder. The zeolite particles have a D50 of approximately 3.6 μm or more. The raw material paste is molded to form a honeycomb molded body. The honeycomb molded body is fired to obtain the honeycomb unit. The honeycomb unit contains zeolite and the inorganic binder and has a plurality of cell walls to define a plurality of cells extending from a first end face to a second end face of the honeycomb unit along a longitudinal direction of the honeycomb unit.

### BRIEF DESCRIPTION OF THE DRAWINGS

Other objects, features and advantages of the present invention will become more apparent from the following detailed description when read in conjunction with the accompanying drawings, in which:

FIG. 1 is a schematic perspective view of a honeycomb structure according to an embodiment of the present invention;

FIG. 2 is a schematic perspective view of another honeycomb structure according to the embodiment of the present invention;

FIG. 3 is a schematic perspective view of a honeycomb unit that is a component of the honeycomb structure of FIG. 2 according to the embodiment of the present invention;

FIG. 4 is a flowchart of a method of manufacturing a honeycomb structure according to the embodiment of the present invention; and

FIG. 5 is a diagram illustrating measurement locations of the average particle size of honeycomb units of examples and comparative examples according to the embodiment of the present invention.

### DESCRIPTION OF THE EMBODIMENTS

With respect to the conventional honeycomb structure, not mere conversion of NOx and the like but further improvement in the rate of conversion of NOx and the like is desired.

According to an embodiment of the present invention, it is possible to obtain a honeycomb structure improved in the rate of conversion of NOx and the like compared with the conventional honeycomb structure. Further, it is possible to obtain a method of manufacturing such a honeycomb structure.

The embodiments will now be described with reference to the accompanying drawings, wherein like reference numerals designate corresponding or identical elements throughout the various drawings.

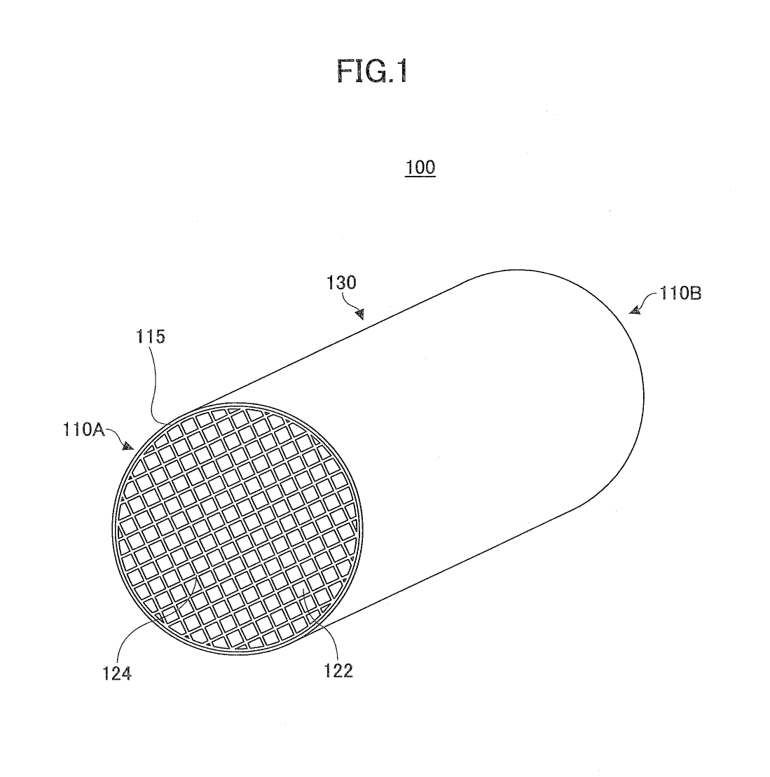

FIG. 1 schematically illustrates a honeycomb structure according to the embodiment of the present invention.

As illustrated in FIG. 1, a honeycomb structure 100 is formed of a single honeycomb unit 130 having two end faces 110A and 110B. The honeycomb structure 100 has an outer peripheral coat layer 115 formed on the side surface of the honeycomb unit 130 excluding the end faces 110A and 110B.

The honeycomb unit 130 includes multiple cells (through holes) 122, extending from one end to another end of the honeycomb unit 130 along its longitudinal directions and open at the end faces 110A and 110B, and cell walls 124 separating the cells 122. In the non-limiting example of FIG. 1, the cross sections of the cells 122 perpendicular to their longitudinal directions (axial directions) are substantially square.

The honeycomb unit 130 is formed of, for example, inorganic particles and an inorganic binder.

Here, in the case of using alumina, silica, titania, ceria, zirconia, mullite, zeolite or the like as the inorganic particles included in a honeycomb unit 130, the honeycomb structure 100 having this honeycomb unit 130 may be used as a catalyst support for converting CO, HC, and/or NOx. In particular, a catalyst support that uses zeolite as inorganic particles may be used for a urea SCR system having a urea tank.

For example, in such a urea SCR system, when exhaust gas is caused to flow through the system, the urea contained in the urea tank reacts with water in the exhaust gas to generate ammonia (Eq. (1)):

CO(NH₂)₂+H₂O→2NH₃+CO₂. (1)

When this ammonia, together with exhaust gas including NOx, flows into each cell 122 from one end face of the honeycomb structure 100 (for example, the end face 110A of the honeycomb unit 130), the reactions of the following Eqs. (2-1) and (2-2) are caused by the action of the zeolite catalyst included in the cell walls 123:

4NH₃+4NO+O₂→4N₂+6H₂O, (2-1)

8NH₃+6NO₂→7N₂+12H₂O. (2-2)

Thereafter, the converted exhaust gas is discharged from another end face of the honeycomb structure 100 (for example, the end face 110B of the honeycomb unit 130). Thus, by causing exhaust gas to flow inside the honeycomb structure 100, NOx in the exhaust gas can be treated.

In the case of converting exhaust gas using the conventional honeycomb structure formed of a honeycomb unit containing zeolite, it is believed that conversion of NOx and the like is not sufficient. One reason for this is believed to be that when exhaust gas is caused to flow through the honeycomb structure, the exhaust gas does not flow sufficiently into pores in the cell walls of the honeycomb unit. However, even if an attempt is made to increase the pore size of pores in the cell walls of the honeycomb unit in order to address this problem, a specific pore size for producing a proper NOx conversion effect is unknown. For example, excessively increasing the pore size of pores in the cell walls of the honeycomb unit in turn causes another problem in that NOx in the exhaust gas is likely to flow out of the honeycomb structure before being converted through catalyst reaction in the cell walls of the honeycomb unit.

On the other hand, in the honeycomb structure 100 according to the embodiment of the present invention, the average pore size of the cell walls 124 of the honeycomb unit 130 is more than or equal to approximately 0.10 μm. If the average pore size is more than or equal to approximately 0.10 μm, pores are so large that NO molecules and the like in the exhaust gas are likely to be allowed into the pores even when the molecular motion of the NO molecules and the like intensifies at high temperatures, so that NOx in the exhaust gas is likely to be allowed to sufficiently enter the pores of the cell walls. This allows the honeycomb structure 100 according to the embodiment of the present invention to improve the NOx conversion rate compared with the conventional honeycomb structure.

Further, the average pore size of the cell walls 124 of the honeycomb unit 130 is less than or equal to approximately 0.50 μm. If the average pore size is less than or equal to approximately 0.50 μm, large pores are less likely to increase in number in the cell walls 124 so that the number of pores of the cell walls 124 is less likely to be reduced. Therefore, NOx in the exhaust gas is likely to enter the pores of the cell walls 124. Accordingly, it is likely to be possible for such a honeycomb structure to improve the NOx conversion rate compared with the conventional honeycomb structure.

Further, the average pore size of the cell walls 124 of the honeycomb unit 130 is preferably approximately 0.10 μm to approximately 0.50 μm, more preferably approximately 0.10 μm to approximately 0.33 μm, and still more preferably, approximately 0.12 μm to approximately 0.33 μm.

In the honeycomb structure 100 according to the embodiment of the present invention, the average particle size of the cell walls 124 of the honeycomb unit 130 is more than or equal to approximately 3.6 μm. If the average particle size of the cell walls 124 is more than or equal to approximately 3.6 μm, the cell walls 124 are likely to have an average pore size of approximately 0.10 μm or more. Further, the average particle size of the cell walls 124 of the honeycomb unit 130 is less than or equal to approximately 7.0 μm. If the average particle size of the cell walls 124 are less than or equal to approximately 7.0 μm, the cell walls 124 are likely to have an average pore size of approximately 0.50 μm or less.

The average pore size of the cell walls 124 of the honeycomb unit 130 may be measured by mercury intrusion porosimetry. The average particle size of the cell walls 124 of the honeycomb unit 130 may be determined by observing cross sections of the cell walls 124 in a direction perpendicular to the cells 122 by scanning electron microscopy (SEM) and measuring the diameters of particles in SEM images or SEM photographs.

### [Configuration of Honeycomb Structure 100]

Here, a brief description is given of the honeycomb unit 130 included in the honeycomb structure 100 illustrated in FIG. 1. Here, a description is given in particular of a case where the honeycomb unit 130 is formed of a material including zeolite as a principal component.

The honeycomb unit 130 contains zeolite and an inorganic binder. The honeycomb unit 130 may further contain inorganic particles other than zeolite. The honeycomb unit 130 may further contain a strength reinforcing material such as inorganic fibers.

Examples of zeolite contained in the honeycomb unit 130 include β-zeolite, zeolite Y, ferrierite, zeolite ZSM-5, mordenite, faujasite, zeolite A, zeolite L, structural analogs of zeolite and the like. Zeolite is preferably β-zeolite or zeolite ZSM-5. Further, preferred structural analogs of zeolite are ALPO (aluminophosphate), SAPO (silico-aluminophosphate) and the like. Further, zeolite may have Fe, Cu, Ni, Co, Zn, Mn, Ti, Ag, V, etc., introduced therein through ion exchange. Of these elements, iron (Fe) or copper (Cu) is preferable in particular, of which iron (Fe) is more preferable.

In particular, if zeolite is ion-exchanged with iron (Fe), it is likely to be possible to improve the NOx conversion rate (the NOx conversion rate at high temperatures in particular).

The inorganic binder contained in the honeycomb unit 130 is desirably a solids content of at least one selected from the group consisting of alumina sol, silica sol, titania sol, water glass, sepiolite, attapulgite, and boehmite.

The inorganic particles other than those of zeolite are preferably of alumina, silica, zirconia, titania, ceria, mullite, etc. These inorganic particles other than those of zeolite may be used alone or in combination.

Of the amount of zeolite contained in the honeycomb unit 130, the lower limit is preferably approximately 70 wt % and more preferably approximately 75 wt %, while the upper limit is preferably approximately 90 wt % and more preferably approximately 85 wt %.

If the amount of zeolite contained in the honeycomb unit 130 is more than or equal to approximately 70 wt %, the NOx conversion rate is less likely to be reduced. If the amount of zeolite contained in the honeycomb unit 130 is less than or equal to approximately 90 wt %, the amount of the inorganic binder contained in the honeycomb unit 130 is less likely to be relatively reduced, so that the strength of the honeycomb unit 130 is less likely to be reduced.

Further, in the case of adding inorganic fibers to the honeycomb unit 130, alumina, silica, silicon carbide, silica-alumina, glass, potassium titanate, aluminum borate or the like is desirable as the inorganic fibers. These may be used alone or in combination. Of the above-described inorganic fibers, alumina is more preferable.

The cell density of the honeycomb unit 130 is preferably in the range of approximately 15.5 to approximately 186 cells/cm² (approximately 100 to approximately 1200 cpsi), more preferably in the range of approximately 46.5 to approximately 170 cells/cm² (approximately 300 to approximately 1100 cpsi), and still more preferably in the range of approximately 62 to approximately 155 cells/cm² (approximately 400 to approximately 1000 cpsi).

The thickness of the cell walls 124 of the honeycomb unit 130 is not limited in particular, but has a preferable lower limit of approximately 0.1 mm in terms of the strength of the honeycomb unit 130 and has a preferable upper limit of approximately 0.4 mm in terms of exhaust gas conversion performance.

The porosity of the honeycomb unit 130 is preferably in the range of approximately 30% to approximately 70%. If the porosity of the honeycomb unit 130 is more than or equal to approximately 30%, it is less likely that NOx in the exhaust gas is less likely to enter the pores of the cell walls 124, so that the NOx conversion rate is less likely to be reduced. If the porosity of the honeycomb unit 130 is less than or equal to approximately 70%, the amount of zeolite is less likely to be relatively reduced, so that the NOx conversion rate is less likely to be reduced. The value of the porosity of the honeycomb unit 130 means a value measured by a weighing method.

The honeycomb unit 130 forming the honeycomb structure 100 according to the embodiment of the present invention is manufactured by molding and firing raw material paste containing zeolite particles whose D50 is more than or equal to approximately 3.6 μm and an inorganic binder. Further, the D50 of the zeolite particles contained in the honeycomb unit 130 is preferably less than or equal to approximately 7.0 μm.

Further, the D50 of the zeolite particles contained in the honeycomb unit 130 is more preferably approximately 3.6 μm to approximately 7.0 μm, and still more preferably, approximately 3.6 μm to approximately 4.5 μm.

Manufacturing the honeycomb unit 130 using zeolite particles whose D50 is approximately 3.6 μm or more as the zeolite particles contained in the honeycomb unit 130 is likely to make it possible for the cell walls 124 of the honeycomb unit 130 to have an average pore size of approximately 0.10 μm or more. This is likely to allow NOx in the exhaust gas to penetrate sufficiently into the pores of the cell walls 124, so that it is likely to be possible to improve the NOx conversion rate of the honeycomb structure 100 compared with that of the conventional honeycomb structure.

Further, manufacturing the honeycomb unit 130 using zeolite particles whose D50 is approximately 7.0 μm or less as the zeolite particles contained in the honeycomb unit 130 is likely to make it possible for the cell walls 124 of the honeycomb unit 130 to have an average pore size of approximately 0.50 μm or less. This is likely to reduce the number of large pores in the cell walls 124, so that the number of pores of the cell walls 124 is likely to increase. As a result, NOx in the exhaust gas is likely to enter the pores, so that it is likely to be possible to improve the NOx conversion rate of the honeycomb structure 100 compared with that of the conventional honeycomb structure.

Here, the “D50” means a particle size value at which the particle size distribution of secondary particles is 50 wt % in terms of volume, and is also referred to as “median diameter.” The D50 of the zeolite particles may be measured using a laser diffraction particle size analyzer (for example, SALD-2200, manufactured by Shimadzu Corporation).

### [Other Configuration of Honeycomb Structure]

The honeycomb structure 100 illustrated in FIG. 1 is a so-called “monolithic” type formed of a single honeycomb unit. However, the embodiment of the present invention may also be applied to a honeycomb structure of a so-called “aggregated” type formed of multiple honeycomb units.

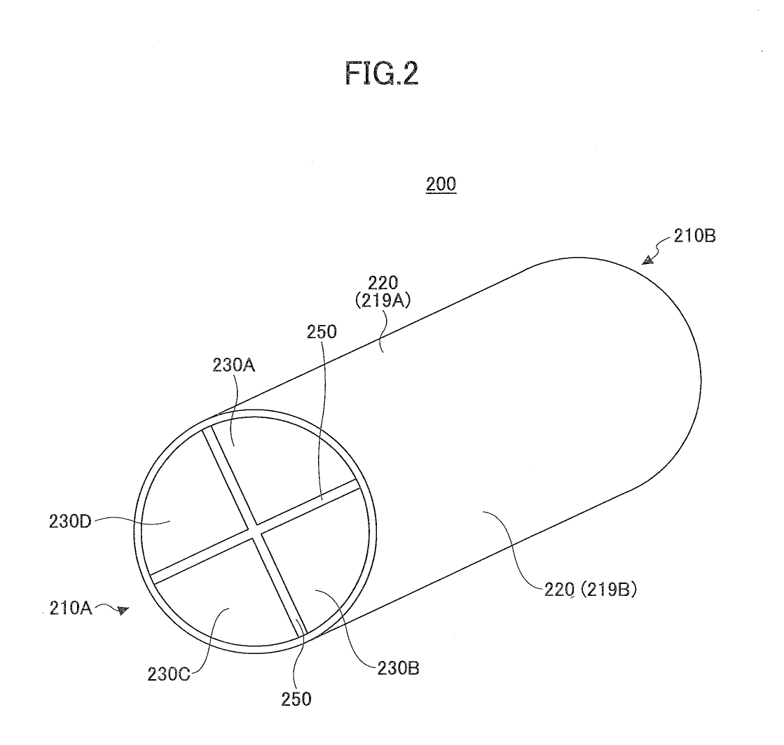

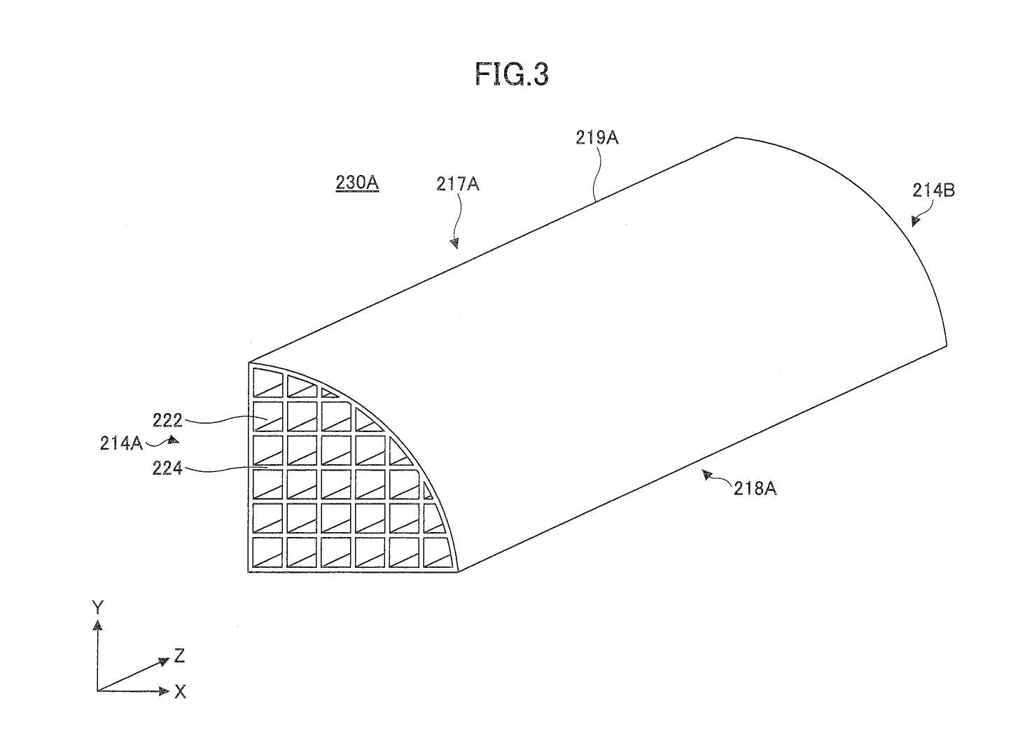

FIG. 2 is a schematic perspective view of another honeycomb structure according to the embodiment of the present invention. FIG. 3 is a perspective view of a honeycomb unit that is a component of the honeycomb structure of FIG. 2.

FIG. 2 illustrates a honeycomb structure 200 of an “aggregated” type according to the embodiment of the present invention. FIG. 3 illustrates a honeycomb unit 230A, which is a component of the honeycomb structure 200 illustrated in FIG. 2.

As illustrated in FIG. 2, the honeycomb structure 200 of the embodiment of the present invention has two open end faces 210A and 210B and a side surface 220. The honeycomb structure 200 includes an outer peripheral coat layer (not graphically illustrated) that defines the side surface 220.

The honeycomb structure 200 is formed by joining multiple honeycomb units by interposing an adhesive layer 250. For example, in the case of FIG. 2, the honeycomb structure 200 is formed of four honeycomb units, that is, honeycomb units 230A through 230D.

These honeycomb units 230A through 230D contain zeolite and an inorganic binder.

As illustrated in FIG. 3, the honeycomb unit 230A has a substantial pillar structure having end faces 214A and 214B having a sectorial shape of a substantially quarter circle and three sides 217A, 218A, and 219A. Of these, the side 217A and the side 218A have a substantially flat surface, and the side 219A has a curved surface (hereinafter referred to as “curved side”).

In the case of FIG. 2, the honeycomb units 230B through 230D have the same shape as the honeycomb unit 230A. For example, as illustrated in FIG. 2, the honeycomb unit 230B has a curved side 219B, which corresponds to the curved side 219A of the honeycomb unit 230A.

The honeycomb unit 230A includes multiple cells (through holes) 222, extending from the end face 214A to the end face 214B along the longitudinal directions of the honeycomb unit 230A and open at the end faces 214A and 214B, and cell walls 224 separating the cells 222. A catalyst such as zeolite may be supported on the cell walls 224.

Here, the average pore size of the cell walls 224 is more than or equal to approximately 0.10 μm. Further, the average pore size of the cell walls 224 may be less than or equal to approximately 0.50 μm.

It is clear to a person having ordinary skill in the art that the effects according to the present invention as described above are also produced by the honeycomb structure 200 having the honeycomb units 230A through 230D.

### Method of Manufacturing Honeycomb Structure According to Embodiment of Present Invention

A description is given in detail below of a method of manufacturing the honeycomb structure 100 formed of a single honeycomb unit illustrated in FIG. 1 according to the embodiment of the present invention.

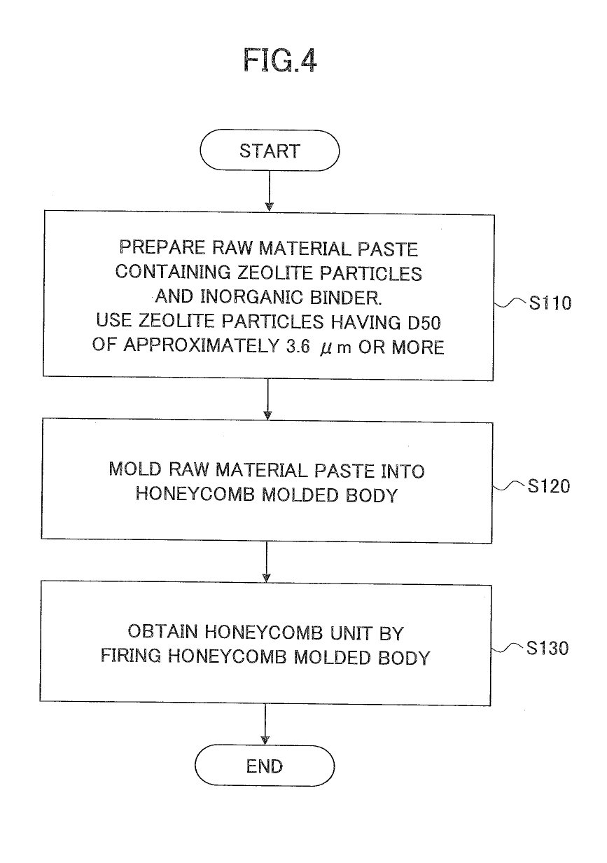

FIG. 4 is a flowchart illustrating a method of manufacturing a honeycomb structure according to the embodiment of the present invention. As illustrated in FIG. 4, the method of manufacturing a honeycomb structure according to the embodiment of the present invention includes:
(a) the process of preparing raw material paste containing zeolite particles and an inorganic binder, where zeolite particles having a D50 of approximately 3.6 μm or more are used (step S110);
(b) the process of forming a honeycomb molded body by molding the raw material paste (step S120); and
(c) the process of obtaining a honeycomb unit by firing the honeycomb molded body (step S130).

A description is given below of each of the processes.

### [Step S110]

First, raw material paste containing zeolite particles and an inorganic binder is prepared. The raw material paste may further contain inorganic particles other than those of zeolite and/or an organic binder. The raw material paste may further contain inorganic fibers. The raw material paste may further contain a dispersion medium such as water and/or a molding aid.

As the zeolite particles, those having a D50 of approximately 3.6 μm or more are used. The D50 of the zeolite particles is preferably less than or equal to approximately 7.0 μm. Here, the “D50” means a particle size value at which the particle size distribution of secondary particles is 50 wt % in terms of volume.

Using zeolite particles having a D50 of approximately 3.6 μm or more is likely to make it possible for the cell walls of a honeycomb unit to be finally obtained to have an average pore size of approximately 0.10 μm or more, so that NOx in the exhaust gas is likely to be allowed to penetrate sufficiently into the pores of the cell walls 124. Further, if the zeolite particles have a D50 of approximately 7.0 μm or less, it is likely to be possible for the cell walls of the honeycomb unit to be finally obtained to have an average pore size of approximately 0.50 μm or less. This is likely to prevent large pores in the cell walls from increasing in number. Therefore, it is likely to be possible to increase the number of pores of the cell walls, so that NOx in the exhaust gas is likely to enter the pores. This is likely to allow the NOx conversion rate of the honeycomb structure to be better than it has been.

The D50 of the zeolite particles is preferably in the range of approximately 3.6 μm to approximately 7.0 μm, more preferably in the range of approximately 3.6 μm to approximately 4.5 μm, and still more preferably, in the range of approximately 3.7 μm to approximately 4.5 μm. Further, the average pore size of the cell walls of the honeycomb unit is preferably in the range of approximately 0.10 μm to approximately 0.50 μm, more preferably in the range of approximately 0.10 μm to approximately 0.33 μm, and still more preferably, in the range of approximately 0.12 μm to approximately 0.33 μm.

The inorganic binder contained in the raw material paste may be at least one selected from the group consisting of, for example, alumina sol, silica sol, titania sol, water glass, sepiolite, attapulgite, boehmite, etc.

The inorganic particles other than those of zeolite contained in the raw material paste are preferably of alumina, silica, zirconia, titania, ceria, mullite or the like. These inorganic particles other than those of zeolite may be used alone or in combination.

The inorganic binder contained in the raw material paste is not limited to but may be one or more selected from, for example, methylcellulose, carboxymethylcellulose, hydroxyethylcellulose, polyethylene glycol, phenolic resin, epoxy resin, etc.

The inorganic fibers contained in the raw material paste are preferably alumina, silica, silicon carbide, silica-alumina, glass, potassium titanate, aluminum borate or the like. These may be used alone or in combination. Of the above-described inorganic fibers, alumina is more preferable.

The dispersion medium contained in the raw material paste is not limited in particular, and may be, for example, water, an organic solvent (such as benzene), alcohol (such as methanol), etc.

The molding aid contained in the raw material paste is not limited in particular, and may be, for example, ethylene glycol, dextrin, a fatty acid, fatty acid soap, polyalcohol, etc., of which two or more may be mixed. Of these, a fatty acid is desirable. Further, the fatty acid is preferably an unsaturated fatty acid, and more preferably a higher fatty acid. The higher fatty acid preferably has a carbon number more than or equal to 15 and less than 65.

The raw material paste is not limited to this, and is preferably subjected to mixing and kneading. For example, the raw material paste may be mixed using a mixer, an attritor, etc., and may be well kneaded with a kneader, etc.

Of the amount of zeolite contained in the raw material paste, the lower limit is preferably approximately 70 wt % and more preferably approximately 75 wt %, while the upper limit is preferably approximately 90 wt % and more preferably approximately 85 wt %. The NOx conversion rate of a manufactured honeycomb structure is likely to be higher with the amount of zeolite contained in the raw material paste in the range of approximately 70 wt % to approximately 90 wt %.

### [Step S120]

Next, a honeycomb molded body is formed by molding the raw material paste prepared in step S110.

The method of molding the raw material paste is not limited in particular. For example, extrusion molding or the like may be used as a molding technique.

### [Step S130]

Next, the honeycomb molded body obtained in the previous process is fired, so that a honeycomb unit (a honeycomb fired body) is manufactured.

The conditions for firing differ depending on the kind of the inorganic particles contained in the honeycomb molded body. The firing temperature is preferably in the range of, for example, approximately 600° C. to approximately 1200° C.

If the firing temperature is more than or equal to approximately 600° C., condensation polymerization through the inorganic binder is likely to progress so that the strength of the honeycomb unit is less likely to be reduced. On the other hand, if the firing temperature is less than or equal to approximately 1200° C., the sintering of the zeolite particles is prevented from excessively progressing so that the reaction sites of the zeolite particles are less likely to be reduced.

An outer peripheral coat layer is formed on the side surface of the honeycomb unit excluding the end faces.

It is possible to manufacture a honeycomb structure as illustrated in FIG. 1 through the above-described processes.

The zeolite particles contained in the raw material paste may be of β-zeolite, zeolite Y, ferrierite, zeolite ZSM-5, mordenite, faujasite, zeolite A, zeolite L, a structural analog of zeolite, etc. Further, the zeolite particles contained in the raw material paste or zeolite in the honeycomb unit may be ion-exchanged with Fe, Cu, Ni, Co, Zn, Mn, Ti, Ag, V, etc. Of these elements, iron (Fe) and copper (Cu) are preferable in particular, of which iron (Fe) is more preferable for the ion exchange.

The method of subjecting zeolite to ion exchange includes a method using ion-exchanged zeolite particles (particularly zeolite ion-exchanged with iron [Fe]). Further, the honeycomb unit (honeycomb fired body) and the honeycomb structure may be manufactured using zeolite particles that are not ion-exchanged, and the process of subjecting zeolite contained in the honeycomb unit or the honeycomb structure to ion exchange (particularly to ion exchange with iron [Fe] by immersing the honeycomb unit or the honeycomb structure in a solution containing iron [Fe] ions) may be performed. That is, more preferably, the method of manufacturing a honeycomb structure according to the embodiment of the present invention further includes (d) the process of subjecting zeolite contained in the honeycomb unit or the honeycomb structure to ion exchange with iron after the processes of (a) through (c). An aqueous ferric nitrate solution or the like may be used as the solution containing iron (Fe) ions.

### [Method of Manufacturing Honeycomb Structure Having Different Structure]

In the case of manufacturing a honeycomb structure formed of multiple honeycomb units as illustrated in FIG. 2, multiple honeycomb units manufactured through the above-described processes are joined by interposing adhesive layer paste.

The adhesive layer paste is not limited in particular, and may be, for example, a mixture of inorganic particles and an inorganic binder, a mixture of an inorganic binder and inorganic fibers, a mixture of inorganic particles, an inorganic binder, and inorganic fibers, etc. An organic binder may further be added to the adhesive layer paste.

The organic binder contained in the adhesive layer paste is not limited in particular, and may be one or more selected from, for example, polyvinyl alcohol, methylcellulose, ethylcellulose, carboxymethylcellulose, etc. Among organic binders, carboxymethylcellulose is preferable.

A honeycomb unit assembly is formed by joining a necessary number of honeycomb units by interposing the adhesive layer paste and drying and solidifying the adhesive layer paste. Thereafter, if necessary, the outer peripheral surface of the obtained honeycomb unit assembly may be cut, for example, cylindrically using a diamond cutter or the like. As a result, a honeycomb structure of a desired shape is manufactured. Alternatively, as the honeycomb unit 230A illustrated in FIG. 3, the honeycomb units may have their shapes so determined in advance as to exactly form the end faces and the side surface of the honeycomb structure when joined. In the case of thus using honeycomb units of predetermined shapes, there is no need to process the outer peripheral surface after joining the individual honeycomb units.

The honeycomb unit assembly thus obtained has an outer peripheral coat layer formed on its outer peripheral surface excluding the end faces.

It is possible to manufacture a honeycomb structure having an aggregated structure as illustrated in FIG. 2 through the above-described processes.

In the honeycomb structure 100 or the honeycomb structure 200 described above, an outer peripheral coat layer may be or may not be formed on the side surface excluding the end faces. The outer peripheral coat layer is formed by drying and solidifying outer peripheral coat layer paste (the same as the adhesive layer paste described below).

### EXAMPLES

A description is given in detail below of the present invention based on examples.

Honeycomb units were manufactured through the following processes, and the conversion performance of the honeycomb units was evaluated.

### Example 1

First, raw material paste for a honeycomb molded body was prepared by mixing 2800 parts by weight of β-zeolite particles having an average particle size of secondary particles of 3 μm (having a D50 of 3.7 μm), 270 parts by weight of alumina fibers (6 μm in average fiber diameter and 100 μm in average fiber length), 1120 parts by weight of boehmite powder (a mixture of 72 mass % of a solids content and 28 mass % of an acetic acid and water), 380 parts by weight of an organic binder (methylcellulose), 310 parts by weight of a lubricant, and 2400 parts by weight of ion-exchanged water as raw materials.

Next, extrusion molding was performed with an extruder using this raw material paste, thereby obtaining a cylindrical honeycomb molded body having a size of 30 mm in diameter and 50 mm in length.

Next, the honeycomb molded body was sufficiently dried using a microwave drying apparatus and a hot air drying apparatus, and was degreased, being held at 400° C. for 2 hours. Thereafter, the honeycomb molded body was fired, being held at 700° C. for 2 hours, so that a honeycomb unit was obtained.

The honeycomb unit has an average pore size of 0.12 μm, an average particle size of 3.7 μm, and a porosity of 55%. The honeycomb unit has a cell wall thickness of 11 mil and a cell density of 420 cpsi.

This is referred to as a honeycomb unit according to Example 1.

In Example 1, as the β-zeolite particles contained in the raw material, those ion-exchanged with iron (Fe) were used. That is, the β-zeolite particles contained in the raw material were subjected to ion-exchange with iron (Fe) by immersing β-zeolite particles in an aqueous ferric nitrate solution.

The amount of ion exchange with iron (Fe) of the β-zeolite was measured by ICP emission spectrometry using an ICPS-8100 (manufactured by Shimadzu Corporation) to be 3.6 mass %.

The D50 of the zeolite particles was measured using a laser diffraction particle size analyzer (SALD-2200, manufactured by Shimadzu Corporation). Further, the average pore size of the honeycomb unit was measured by mercury intrusion porosimetry (with a mercury porosimeter). The cell wall thickness was determined from SEM observations (SEM photographs) of cross sections of cell walls in a direction perpendicular to the cells.

Further, the average particle size of the honeycomb unit was measured from the results of SEM observations at predetermined points of the honeycomb unit.

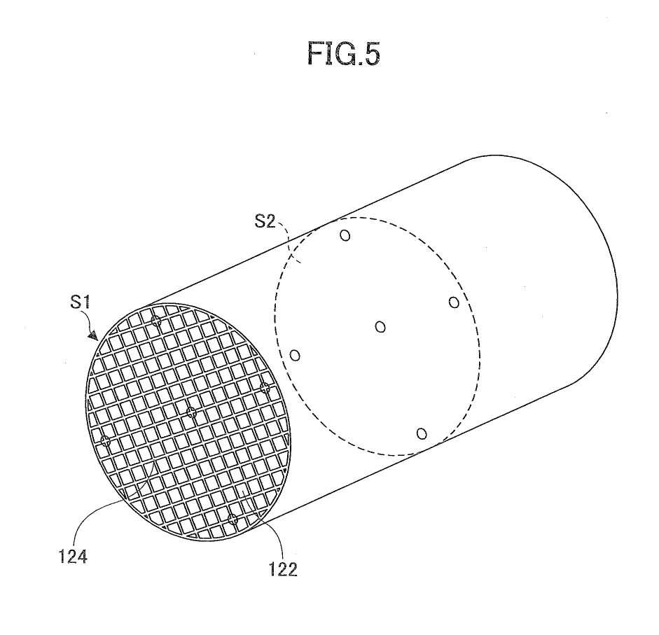

FIG. 5 illustrates measurement locations of the average particle size of the honeycomb unit. The points indicated by circles in FIG. 5 are measurement locations of the average particle size.

The ten points in the honeycomb unit illustrated in FIG. 5, that is, five points in one end face S1 of the honeycomb unit and five points in a cross section S2 perpendicular to a longitudinal direction of the honeycomb unit at the center of the honeycomb unit in the longitudinal direction (at the position equally distant from both end faces), were selected as measurement locations of the average particle size.

The five measurement positions in the end face S1 were one cell wall 124 in the substantial center part in the plane and four cell walls 124 substantially symmetrically arranged in crisscross directions (at a distance of approximately 10 mm from the peripheral edge of the end face S1). The same is the case with the five measurement positions in the cross section S2.

At each point, an SEM photograph of a cell wall end face or cross section was taken, and the particle size was measured with respect to five zeolite particles per measurement point. The average of the obtained particle size data of the total of 50 zeolite particles was determined as the average particle size of the honeycomb unit.

In measuring the particle size of zeolite, zeolite particles of appropriate size were selected from the SEM photographs. Further, since zeolite particles are coupled to each other, an outline supposed to be one zeolite particle was created, and a maximum length passing through the center was determined as the particle size of the particle.

### Example 2

A honeycomb unit according to Example 2 was manufactured in the same manner as in Example 1. In Example 2, however, zeolite particles having a D50 of 4.2 μm were used. Therefore, the obtained honeycomb unit had an average pore size of 0.20 μm, an average particle size of 4.2 μm, and a porosity of 55%.

### Example 3

A honeycomb unit according to Example 3 was manufactured in the same manner as in Example 1. In Example 3, however, zeolite particles having a D50 of 4.5 μm were used. Therefore, the obtained honeycomb unit had an average pore size of 0.33 μm, an average particle size of 4.5 μm, and a porosity of 55%.

### Example 4

A honeycomb unit according to Example 4 was manufactured in the same manner as in Example 1. In Example 4, however, zeolite particles having a D50 of 3.6 μm were used. Therefore, the obtained honeycomb unit had an average pore size of 0.10 μm, an average particle size of 3.6 μm, and a porosity of 55%.

### Comparative Example 1

A honeycomb unit according to Comparative Example 1 was manufactured in the same manner as in Example 1. In Comparative Example 1, however, zeolite particles having a D50 of 3.5 μm were used. Therefore, the obtained honeycomb unit had an average pore size of 0.08 μm, an average particle size of 3.5 μm, and a porosity of 55%.

### Comparative Example 2

A honeycomb unit according to Comparative Example 2 was manufactured in the same manner as in Example 1. In Comparative Example 2, however, zeolite particles having a D50 of 2.5 μm were used. Therefore, the obtained honeycomb unit had an average pore size of 0.04 μm, an average particle size of 2.5 μm, and a porosity of 55%.

The D50 of the raw material zeolite particles used in manufacturing each honeycomb unit, the average pore size of each honeycomb unit obtained, and the average particle size of each honeycomb unit obtained are illustrated together in Table 1.

TABLE 1

| | | AVERAGE | AVERAGE | NOx |
|---|---|---|---|---|
| | D50 OF | PORE SIZE | PARTICLE | CON- |
| | RAW MA- | OF HON- | SIZE OF | VER- |
| | TERIAL | EYCOMB | HONEYCOMB | SION |
| | ZEOLITE | UNIT | UNIT | RATE |
| | (μm) | (μm) | (μm) | (%) |
| EXAMPLE 1 | 3.7 | 0.12 | 3.7 | 80 |
| EXAMPLE 2 | 4.2 | 0.20 | 4.2 | 82 |
| EXAMPLE 3 | 4.5 | 0.33 | 4.5 | 80 |
| EXAMPLE 4 | 3.6 | 0.10 | 3.6 | 78 |
| COMPAR- | 3.5 | 0.08 | 3.5 | 65 |
| ATIVE | | | | |
| EXAMPLE 1 | | | | |
| COMPAR- | 2.5 | 0.04 | 2.5 | 58 |
| ATIVE | | | | |
| EXAMPLE 2 | | | | |

### [Evaluation of Conversion Performance]

The conversion performance of the honeycomb units was evaluated as follows.

First, gas fed from a simulated exhaust gas generator (SIGU-2000, manufactured by HORIBA, Ltd.) was caused to flow through each of the honeycomb units of Examples 1 to 4 and Comparative Examples 1 and 2 with one end face and another end face of each of the honeycomb units serving a gas entrance side and a gas exit side, respectively.

After a steady state was reached, a NOx concentration “C1” in the fed gas before introduction into the honeycomb unit and a NOx concentration “C2” in the gas discharged from the honeycomb unit were measured with a NOx measuring apparatus (MEXA-6000FX, manufactured by HORIBA, Ltd.) with respect to each of the honeycomb units.

The NOx conversion rates of the honeycomb units of Examples 1 to 4 and Comparative Examples 1 and 2 were calculated from the obtained results of the NOx concentration measurement using Eq. (3) as follows:

NOx conversion rate(%)=(C1−C2)/(C1)×100. (3)

The feed rate of the fed gas was 140,000 in space velocity (SV). The fed gas was based on nitrogen gas and contained NO₂ gas, NOx gas, and NH₃ gas. The NO₂ to NOx ratio of the fed gas was NO₂/NOx=0.25, and the NH₃ to NOx ratio of the fed gas was NH₃/NOx=1.

The test temperature of the evaluation of conversion performance was 500° C.

The NOx conversion rates obtained in the honeycomb units are illustrated together in Table 1 shown above. Table 1 shows that the NOx conversion rates of the honeycomb units according to Example 1 through Example 4 are 80%, 82%, 80%, and 78%, respectively, showing that all of the NOx conversion rates are 75% or more and good conversion performance (NOx conversion rates) is obtained. On the other hand, the honeycomb units according to Comparative Example 1 and Comparative Example 2, whose NOx conversion rates are 65% and 58%, respectively, were low in conversion performance (NOx conversion rate).

It has been confirmed that by thus causing the D50 of zeolite particles to be approximately 3.6 μm or more, the conversion performance (NOx conversion rate) is significantly improved. (In Example 1 through Example 4, the D50 is in the range of 3.6 μm to 4.5 μm, and the average pore size of the honeycomb unit is in the range of 0.10 μm to 0.33 μm.)

In Examples 1 through 4 and Comparative Examples 1 and 2, the NOx conversion rate was evaluated using a honeycomb unit of 30 mm in diameter and 50 mm in length. However, the same results of NOx conversion rate measurement as in Examples 1 through 4 and Comparative Examples 1 and 2 are believed to be obtained in larger-size honeycomb structures (the honeycomb structures 100 and 200) manufactured in the same manner as in Examples 1 through 4 and Comparative Examples 1 and 2.

Obviously, numerous modifications and variations of the present invention are possible in light of the above teachings. It is therefore to be understood that within the scope of the appended claims, the invention may be practiced otherwise than as specifically described herein.

What is claimed is:

1. A honeycomb structure comprising:
a honeycomb unit containing zeolite and an inorganic binder and having a plurality of cell walls to define a plurality of cells extending from a first end face to a second end face of the honeycomb unit along a longitudinal direction of the honeycomb unit;
the honeycomb unit being manufactured by molding and firing raw material paste containing zeolite particles and the inorganic binder, the zeolite particles having a D50 of approximately 3.6 μm or more;
an average pore size of the cell walls being more than or equal to approximately 0.10 μm and less than or equal to approximately 0.50 μm; and
an average particle size of the cell walls being more than or equal to approximately 3.6 μm and less than or equal to approximately 7.0 μm.

2. The honeycomb structure as claimed in claim 1, wherein the D50 of the zeolite particles is less than or equal to approximately 7.0 μm.

3. The honeycomb structure as claimed in claim 1, wherein a weight ratio of the zeolite contained in the honeycomb unit to the honeycomb unit is more than or equal to approximately 70 wt %.

4. The honeycomb structure as claimed in claim 1, wherein the zeolite is obtained by ion-exchange with iron.

5. The honeycomb structure as claimed in claim 1, wherein the honeycomb structure includes a plurality of the honeycomb units.

6. The honeycomb structure as claimed in claim 1, wherein the honeycomb structure is formed of the single honeycomb unit.

7. The honeycomb structure as claimed in claim 1, wherein the average pore size of the cell walls is more than or equal to approximately 0.12 μm and less than or equal to approximately 0.33 μm.

8. The honeycomb structure as claimed in claim 1, wherein the honeycomb unit contains inorganic particles other than the zeolite.

9. The honeycomb structure as claimed in claim 8, wherein the inorganic particles other than the zeolite are alumina particles, silica particles, zirconia particles, titania particles, ceria particles, mullite particles, or a combination thereof.

10. The honeycomb structure as claimed in claim 1, wherein the zeolite is β-zeolite, zeolite Y, ferrierite, zeolite ZSM-5, mordenite, faujasite, zeolite A, zeolite L, or a structural analog of zeolite.

11. The honeycomb structure as claimed in claim 1, wherein the zeolite is one of β-zeolite and zeolite ZSM-5.

12. The honeycomb structure as claimed in claim 1, wherein the zeolite is one of aluminophosphate (ALPO) and silico-aluminophosphate (SAPO).

13. The honeycomb structure as claimed in claim 1, wherein the zeolite is obtained by ion-exchange with Fe, Cu, Ni, Co, Zn, Mn, Ti, Ag, or V.

14. The honeycomb structure as claimed in claim 1, wherein the zeolite is obtained by ion-exchange with one of Fe and Cu.

15. The honeycomb structure as claimed in claim 1, wherein the inorganic binder is a solid content of alumina sol, silica sol, titania sol, water glass, sepiolite, attapulgite, boehmite or a combination thereof.

16. The honeycomb structure as claimed in claim 1, wherein an upper limit of a content of the zeolite contained in the honeycomb unit to the honeycomb unit is approximately 90 wt %.

17. The honeycomb structure as claimed in claim 1, wherein the D50 of the zeolite particles is in a range of approximately 3.6 μm to approximately 4.5 μm.

18. The honeycomb structure as claimed in claim 1, wherein the honeycomb unit has a substantial pillar structure having end faces provided at each of the end portions of a longitudinal direction of the substantial pillar structure and three sides provided around the longitudinal direction, the end faces each having a sectorial shape of a substantially quarter circle.

19. The honeycomb structure as claimed in claim 1, further comprising:
a catalyst supported on the cell walls.

20. The honeycomb structure as claimed in claim 1, wherein the honeycomb structure is used for a urea selective catalytic reduction system.

21. A method of manufacturing a honeycomb structure including a honeycomb unit, the method comprising:
preparing raw material paste containing zeolite particles and the inorganic binder, the zeolite particles having a D50 of approximately 3.6 μm or more;
molding the raw material paste to form a honeycomb molded body; and
firing the honeycomb molded body to obtain the honeycomb unit, the honeycomb unit containing zeolite and the inorganic binder and having a plurality of cell walls to define a plurality of cells extending from a first end face to a second end face of the honeycomb unit along a longitudinal direction of the honeycomb unit.

22. The method of manufacturing a honeycomb structure as claimed in claim 21, wherein the D50 of the zeolite particles is less than or equal to approximately 7.0 μm.

23. The method of manufacturing a honeycomb structure as claimed in claim 21, wherein an average pore size of the honeycomb unit is more than or equal to approximately 0.10 μm and less than or equal to approximately 0.50 μm.

24. The method of manufacturing a honeycomb structure as claimed in claim 23, wherein the average pore size of the honeycomb unit is more than or equal to approximately 0.12 μm and less than or equal to approximately 0.33 μm.

25. The method of manufacturing a honeycomb structure as claimed in claim 21, wherein an average particle size of the honeycomb unit is more than or equal to approximately 3.6 μm and less than or equal to approximately 7.0 μm.

26. The method of manufacturing a honeycomb structure as claimed in claim 21, wherein the zeolite particles are obtained by ion-exchange with iron.

27. The method of manufacturing a honeycomb structure as claimed in claim 21, further comprising:
subjecting the zeolite contained in the honeycomb unit to ion exchange with iron.

28. The method of manufacturing a honeycomb structure as claimed in claim 21, wherein the raw material paste further contains inorganic fibers, an organic binder or a combination thereof.

29. The method of manufacturing a honeycomb structure as claimed in claim 21, further comprising:
preparing a plurality of the honeycomb units; and
interposing an adhesive layer between each of the plurality of the honeycomb units to join the plurality of the honeycomb units with each other.

30. The method of manufacturing a honeycomb structure as claimed in claim 21, wherein the raw material paste includes inorganic particles other than the zeolite particles, an organic binder or a combination thereof.

31. The method of manufacturing a honeycomb structure as claimed in claim 21, the honeycomb molded body is fired at a temperature of approximately 600° C. to approximately 1200° C.

32. The method of manufacturing a honeycomb structure as claimed in claim 21, wherein the honeycomb unit includes inorganic particles other than the zeolite.

33. The method of manufacturing a honeycomb structure as claimed in claim 32, wherein the inorganic particles other than the zeolite are alumina particles, silica particles, zirconia particles, titania particles, ceria particles, mullite particles, or a combination thereof.

34. The method of manufacturing a honeycomb structure as claimed in claim 21, wherein the zeolite is β-zeolite, zeolite Y, ferrierite, zeolite ZSM-5, mordenite, faujasite, zeolite A, zeolite L, or a structural analog of zeolite.

35. The method of manufacturing a honeycomb structure as claimed in claim 21, wherein the zeolite is one of β-zeolite and zeolite ZSM-5.

36. The method of manufacturing a honeycomb structure as claimed in claim 21, wherein the zeolite is one of aluminophosphate (ALPO) and silico-aluminophosphate (SAPO).

37. The method of manufacturing a honeycomb structure as claimed in claim 21, wherein the zeolite is obtained by ion-exchange with Fe, Cu, Ni, Co, Zn, Mn, Ti, Ag, or V.

38. The method of manufacturing a honeycomb structure as claimed in claim 21, wherein the zeolite is ion-exchanged with one of Fe and Cu.

39. The method of manufacturing a honeycomb structure as claimed in claim 21, wherein the inorganic binder is a solid content of alumina sol, silica sol, titania sol, water glass, sepiolite, attapulgite, boehmite or a combination thereof.

40. The method of manufacturing a honeycomb structure as claimed in claim 21, wherein a lower limit and an upper limit of a content of the zeolite contained in the honeycomb unit to the honeycomb unit is approximately 70 wt % and approximately 90 wt %, respectively.

41. The method of manufacturing a honeycomb structure as claimed in claim 21, wherein the D50 of the zeolite particles is in a range of approximately 3.6 μm to approximately 4.5 μm.
